(19) United States
(12) Patent Application Publication
(10) Pub. No.: US 2019/0163327 A1
(43) Pub. Date: May 30, 2019

(54) DISPLAY AND ANALYSIS SYSTEM FOR MEDIA CONTENT

(71) Applicant: Ad Fontes Media, Inc., Westminster, CO (US)

(72) Inventor: Vanessa L. Otero, Westminster, CO (US)

(21) Appl. No.: 16/204,795

(22) Filed: Nov. 29, 2018

Related U.S. Application Data
(60) Provisional application No. 62/726,347, filed on Sep. 3, 2018.
(60) Provisional application No. 62/592,397, filed on Nov. 29, 2017.

(51) Int. Cl. G06F 3/0482; G06F 16/904; G06F 16/908

(52) U.S. Cl. CPC G06F 3/0482; G06F 16/908; G06F 16/904

(57) ABSTRACT

An interactive display system comprising an interactive graphical user interface application displaying a graph having a y-axis representing measures of information source quality and an x-axis representing measures of information source bias, and at least one graphical representation of an information source. The system comprises one or more databases comprising quality data and bias data about the information source represented by the at least one graphical representation, the one or more databases configured to provide the information source quality data and information source bias data to the interactive graphical user interface application. The system comprises a ranking application configured to automatically place the graphical representation on the graph; and automatically update, based on new quality data and new bias data, the coordinate position placement of the graphical representation, wherein one or more graphical elements changes visually upon a user interaction with the one or more graphical elements.

### CROSS-REFERENCE TO RELATED APPLICATIONS

The present application claims priority to U.S. Provisional Applications 62/592,397, filed Nov. 29, 2017, and 62/726,347, filed Sep. 3, 2018, and assigned to the assignee hereof and hereby expressly incorporated by reference herein.

### FIELD

The present disclosure pertains to systems and methods for analyzing media content and visually displaying analysis results. In particular, but without limitation, the disclosure relates to algorithms for assessing characteristics of text and visual media, and displaying interactive metrics and results on a graphical user interface.

### BACKGROUND

Given the proliferation of social media and the associated ease of spreading information, sources from which individuals can get news have recently exploded in number. Years ago, news consumers only had print media such as newspapers and magazines on which to rely. Later, they got news from the radio; after that, network television; and after that, cable television. Twenty-four hour news networks began providing shows to create the modern-day news cycle. The internet lowered the barrier of entry for organizations or individuals wanting to begin providing news, and thousands of sites that actually provide news or purport to provide news now comprise the modern media landscape. Social media, search engines, and systems for internet ad displays provide numerous incentives for individuals and organizations to provide content of varying quality for coveted “clicks” and “views.”

Problems with the proliferation of new kinds of media content have come into sharp focus recently. The spread of “fake news”—hoaxes that appear to come from news sources have been identified as particularly problematic and have become a target for tech companies, individuals, and governments to try to eliminate from spreading. Individual lies and misleading information in any sort of news source have also become a target for identification and elimination. In response, numerous fact-checking organizations have arisen to methodically debunk and disprove dubious claims.

Beyond the problem of fake news and outright lies in news sources, individuals engaging in political discourse often assert that problems of bias—particularly political bias—pervade the stories that they read and watch. Observations of most people's complaints about the news on social media reveal that they are often limited to criticizing particular news sources or stories as “biased,” “unreliable,” or “fake.” Such complaints are general and vague, and most news consumers have difficulty expressing exactly how and why a source or story is bad, in their view. A need exists to help news consumer easily distinguish and communicate the quality and bias of news sources.

### SUMMARY

An aspect of the disclosure provides an interactive display system for visualization of data quantifying information source quality and information source bias. The display system may comprise an interactive graphical user interface application displaying a graph having at least two axes. The axes themselves may comprise a y-axis representing measures of the information source quality; and an x-axis representing measures of the information source bias, and at least one graphical representation of an information source. The system may comprise one or more databases comprising information source quality data and information source bias data about the information source represented by the at least one graphical representation on the graph. The one or more databases may be configured to provide the information source quality data and information source bias data to the interactive graphical user interface application. The system may also comprise a ranking application configured to automatically place, based on the information source quality data, the information source bias data, and a graph placement algorithm, the graphical representation at a particular coordinate position placement on the graph; and automatically update, based on at least one of new information source quality data and new information source bias data, the coordinate position placement of the graphical representation. One or more graphical elements may change visually upon a user interaction with the one or more graphical elements.

### BRIEF DESCRIPTION OF THE DRAWINGS

FIG. 1 shows an exemplary graph that may be displayed on a graphical user interface of the interactive display system of the present disclosure.

FIG. 2A shows an exemplary method for implementing an aspect of the present disclosure for ranking and displaying an information source.

FIG. 2B shows an exemplary method for implementing an aspect of the present disclosure for ranking and displaying an individual article or show.

FIG. 3 shows an embodiment of an interactive display system of the present disclosure in which single information sources are searchable and viewable.

FIG. 4 shows an embodiment of an interactive display system of the present disclosure in which single information sources are searchable and viewable and may be subset into multiple components.

FIG. 5 shows an embodiment of an interactive display system of the present disclosure in which chosen subsets of information sources may be selected for viewing by a user.

FIG. 6 is a logical block diagram of components that may be used to implement aspects of the present disclosure.

FIG. 7 shows an embodiment of an interactive display system of the present disclosure in which individual articles are searchable, viewable, and selectable by a user.

FIG. 8 shows an embodiment of an interactive display system of the present disclosure in which individual article and/or show information may be displayed upon a user interaction with a graphical element of the display.

FIG. 9 shows a rubric for assigning one or more scores to elements of an individual article, which may be used in data gathering processes of the present disclosure.

FIG. 10 rubric for assigning one or more scores to elements of an individual show, which may be used in data gathering processes of the present disclosure.

FIG. 11 illustrates a method for using scoring inputs and algorithms of the present disclosure to automatically rank and graphically display individual articles or shows and information sources on an interactive display.

FIG. 12 is a logical block diagram of a computer that may be used to implement one or more aspects of the present disclosure.

### DETAILED DESCRIPTION

The present disclosure provides systems and methods for analyzing multiple factors in news media stories and then presenting them along multiple dimensions in easy-to-understand visual formats. An aspect of the disclosure relates to methods for measuring and evaluating factors of quality and bias of news media sources and stories. For the purposes of the present disclosure, “news media stories” may refer to written articles in print or on the internet, video clips on the internet or television, and combinations of the two, which are presented to readers or viewers for the purpose of providing any kind of information about current events. “News media sources,” or simply “information sources” may refer to journalism outlets, including print and online newspapers, print and online magazines, network TV broadcast stations, local TV stations, cable broadcast channels, cable broadcast individual shows, internet shows, radio stations and shows, online news sites, online news aggregators or feeds, app-based aggregators or feeds, and any other type of organizer, distributor, or publisher of news media stories.

Existing ways of measuring the news are often limited to measuring limited factors within news stories. Fact-checking organizations, for example, often only evaluate statements that are verifiable. However, many statements within an article or story are opinion or analysis statements and are not verifiable. This necessarily limits the scope of what fact-checking organizations can evaluate. Other ways of measuring the news is measuring characteristics of readers or viewers of the news, such as polling to ask what news consumers think about a particular story or source. Polled individuals may be asked what they find trustworthy, credible, or biased, for example. However, these polls aren't actually measuring much about the content of the news, but rather, attempting to draw conclusions about the content of news by the proxy of people's opinions of it. The most predominant way of measuring news content is by measuring “engagement.” Tech companies have gotten extremely proficient at tracking how many page visits a site or an article gets, how much time a user spends on each page, what the user clicks on from there, what a user likes on social media, what a user comments on in social media, and so forth. Large monetary incentives exist for content producers to measure engagement with their content on a microscopic level, because if they can attract more visitors and views, they can command higher rates from advertisers. However, measuring engagement still doesn't do much to measure the content of the news itself. At best, it measures characteristics of a news source's viewers, much like polling.

To the extent that organizations try to measure news media stories and sources, they often do so by judging or rating partisan bias. Because it is difficult to define standards and metrics by which partisan bias can be measured, such ratings are often made through admittedly subjective assessments by the raters, or are made by polling the public or a subset thereof. High levels of subjectivity can cause the public to be skeptical of ratings results, and polling subsets of the public can skew results in a number of directions.

Another way individuals and organizations have attempted to rate partisan bias is through software-enabled text analysis. The idea of text analysis software is appealing to researchers because the sheer volume of text of news sources is enormous. Social media companies, advertisers, and other organizations have recently used such software to perform “sentiment analysis” of content such as social media posts in order to identify how individuals and groups feel about particular topics, with the hopes that knowing such information can influence purchasing behavior. Some have endeavored to measure partisan bias in this way, by programming software to count certain words that could be categorized as “liberal” or “conservative.” However, such attempts to rate partisan bias have had mixed results, at best, because of the variation in context in which these words are presented. For example, if a word is used sarcastically, or in a quote by someone on the opposite side of the political spectrum from the side that uses that word, then the use of the word is not necessarily indicative of partisan bias. Often, other factors within an individual article or story are far more indicative of bias.

To date, most attempts to measure and rate news have been in terms of either fact-checking, or partisan bias, both of which have serious limitations as described above. However, it is not as if media research about the content of stories does not exist; journalism departments at major universities often engage in large-scale media research projects, and those can look at more specific qualities and factors of a subset of media. Valuable insights are available to readers of the publications resulting from such projects. However, those insights are only available inasmuch as one reads them, and such publications are often only read by those in academic circles, journalists, and those with a high level of sophistication about news media already.

Today, more news sources, articles, and stories are available to consumers than ever before. A significant portion of the population gets its news online, and specifically (and sometimes solely) through social media. The very news that is presented to them on such platforms in often governed by an algorithm that predicts what the user is likely to read. As people engage in political discourse on social media, they often use articles and videos from such sources to support their viewpoints. Many news consumers have trouble evaluating the quality and credibility of the articles they read and videos and shows they watch. To the extent they want help evaluating these sources, their options are limited to the existing fact-checking services and partisanship ratings. When peers argue about whether a story is credible or biased, it is difficult for them to understand themselves why and how such a story is not credible and is biased. It is magnitudes more difficult to convince someone with whom one is having a disagreement why their source is not credible or is biased.

The present system provides methods for evaluating news media stories and sources across multiple factors and several dimensions, beyond fact-checking and conventional partisan bias ratings. The system also provides display mechanisms for conveying the results of such evaluations in simple, digital, interactive, and shareable formats accessible to anyone who uses the Internet. It is contemplated that in many embodiments, the methods of evaluating may be performed by human editors, who may score articles based on criteria described herein. In other embodiments, the methods of evaluating may be performed by a combination of software text analysis and human editorial review. In some embodiments, artificial intelligence machine learning software may perform the methods of evaluating. It is also contemplated that software may be used to calculate mathematical results of human and/or software evaluation, and that software will also be used to automatically display the results of the evaluation and calculation on computer graphical user interfaces.

In embodiments, methods for analyzing news media sources (also referred to herein as “information sources”) and stories may include algorithms for measuring numerous factors over two or more dimensions. These dimensions may comprise one that can be referred to as “overall quality.” This dimension may be represented by the y-axis and may represent measures of information source quality. Another one that can be referred to as “partisanship” or simply “bias.” This dimension may be represented by the x-axis and may represent specific measures of information source bias. Other dimensions may also be measured through multiple factors. These dimensions may include “influence,” “ownership,” “audience size,” “popularity,” and “topic selection,” but may include others. Rankings along of these dimensions may be presented in various kinds of displays, which will be discussed later in this disclosure.

Aspects of the disclosure for evaluating information sources and individual articles and shows may involve assigning “scores” to individual measures of quality and/or bias. Scores, as referred to herein, may comprise binary scores (e.g., yes/no), raw numerical scores on quantitative or qualitative scales, and assignments to a particular category. Ways in which sources and articles may be scores are described in detail throughout this disclosure.

One method for evaluating news media sources in the dimension of “overall quality” may comprise assigning a yes or no answer to each of the following factors:
a. Whether it exists in print;
b. Whether it exists on TV, and if so, whether it existed before cable;
c. Whether it exists on radio, and if so, whether it existed before satellite radio; and
d. Whether the source actively differentiates between opinion and reporting pieces.

Then, the method may comprise assigning numerical answers to each of the following factors:
e. Length of time established;
f. Readership/Viewership; and
g. Number of journalists and staff.

The system of the present disclosure may comprise one or more databases, which will be described in more detail later in this disclosure. At least one of these databases may comprise numerical values, derived from recent research, for several quantitative measures indicative of news source quality. The method may comprise retrieving these numerical values from the database for at least the following factors:
h. Percentage of news media stories that fall into each quality category of news story quality (as defined later in this disclosure);
i. Repetition of same news stories; and
j. Number of stories produced per day.

Additional factors may be added to this list and used to score news sources. In some embodiments, factors may be added based on user surveys or studies of factors that tend to indicate increased quality of news sources.

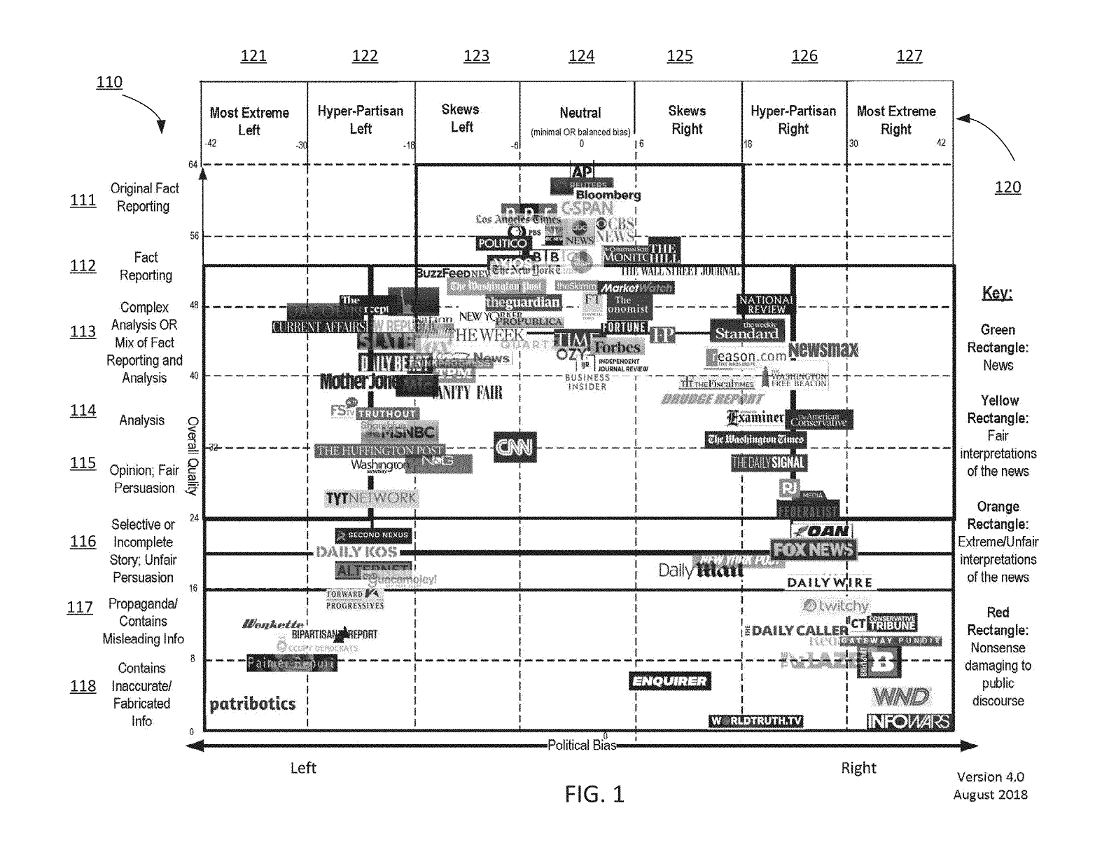

The method may then comprise calculating a position of placement on an “overall quality” dimension of a two-dimensional visual chart. An exemplary two-dimensional chart 100 is shown in FIG. 1. As shown, a vertical axis 110 depicts an overall quality dimension which is subdivided into eight categories 111-118. The eight categories may comprise descriptions of types of news that may be found in news sources within that category. It is contemplated that more or fewer categories may comprise the vertical “overall quality” dimension, or that the descriptions may be different in other embodiments. It is also contemplated that the positions of sources in the categories may represent a strict quantitative score in some embodiments and may not represent a strict quantitative score in others. The distances between the categories may or may not represent a quantitative scale. The calculation of a position on the vertical dimension may be based on an algorithm utilizing several or all of the factors listed above. An exemplary algorithm may comprise initially assigning a source to a vertical location based on answers to factors a-d listed above. For example, a “yes” answer to “whether the source exists in print” may initially assign a source to the middle of the top two categories 111-112. “No” answers may initially assign a source to a position in the middle of the chart, between categories 115 and 116. The initial placements may or may not correspond to the descriptions of the categories but may be used as a baseline for adjusting the position of the source up or down based on other factors.

The algorithm may further comprise adjusting the vertical placement up or down based on the numerical answers to factors e-g above. In some embodiments, this step may comprise establishing a benchmark source having the highest value of all sources for that factor. For example, the oldest source for factor e (length of time established), the source largest readership or viewership number for factor f, and the source with the largest number of journalists and staff for factor g may be the benchmark sources and benchmark numbers against which other sources' vertical rankings may be adjusted. For example, if a source with the highest number of journalists has 2500 journalists, then its vertical placement may be pushed to the top of the vertical dimension, and sources with fewer journalists would be placed under it. Similarly, sources with the highest readership would be placed closer to the top. Depending on the embodiment, the order in which these factors are considered and implemented to move a source up or down may be different.

The algorithm may further comprise adjusting the vertical placements upwards or downwards based on the numerical values retrieved from the database for factors h-j. The numerical values for these factors may have the greatest weight in the final placement of the source within the actual vertical categories 111-118. In particular, factor h, the percentage of stories that fall into each quality category of news story quality (as defined later in this disclosure) may have the greatest weight in some embodiments. In some embodiments, this factor may be used to calculate an initial placement along the vertical axis, within the category 111-118 that the largest percentage of its stories falls into. In such embodiments, the other factors (e.g., a-d) may be used secondarily to move the source up or down only within that category (for example, a source that is initially placed in category 116 “selective or incomplete story; unfair persuasion,” may only be moved up within its category due to a larger number of journalists or larger readership. In other embodiments, viewership or readership may not be included as a factor on the vertical scale at all, and may be represented in a different dimension altogether. For example, in some embodiments of the visual display, the chart may be interactive on a graphical user interface. A user may be able to hover over or click on a source on the chart with a mouse, and a visual indicator may expand to show a relative size of the source in relation to other sources. For example, a proportionate circle may fill the display to represent the number of viewers or readers of a source. Any of the images on the graph or chart may be referred to as graphical elements. Embodiments of these type of visualization will be discussed later in this disclosure.

As previously mentioned, the system of the disclosure may comprise one or more databases. Information in these databases may comprise numerical values, derived from recent research, for several quantitative measures indicative of partisanship. The research may be created by manual ratings by human analysts, by automated ratings by machine learning programs or other software programs, or a combination of both. The method for evaluating news media sources in the dimension of “partisanship” may comprise retrieving these numerical values from the database for at least the following factors:
a. Percentage of news media stories falling within each partisanship category (as defined later in this disclosure);
b. Reputation for a partisan point of view among other news sources (as measured by factors defined later in the disclosure);
c. Reputation for a partisan point of view among the public (as measured by surveys); and
d. Party affiliation of regular journalists, contributors, and interviewees.

Additionally, the method for evaluating news media sources on the dimension of partisanship may further comprise the following factor:
e. Presence of an ideological reference or party affiliation in the title of the source

It is contemplated that additional factors may be added to this list and used to rate news sources on the dimension of partisanship. In some embodiments, factors may be added based on user surveys or studies of factors that tend to indicate partisanship of news sources.

The method may then comprise calculating a position of placement of a source on a “partisanship” or “bias” dimension of the two-dimensional visual chart. Referring still to FIG. 1, a horizontal axis (x-axis) 120 depicts a partisanship dimension which is subdivided into seven categories 121-127. The seven categories may comprise descriptions of degrees of partisanship, with a middle category 124 representing a center and categories to the left and right representing degrees of left-leaning political bias (121-123) and right-leaning political bias (125-127). It is contemplated that more or fewer categories may comprise the horizontal “partisanship” dimension, or that the descriptions may be different in other embodiments. It is also contemplated that the positions of sources in the categories may represent a strict quantitative score in some embodiments and may not represent a strict quantitative score in others. The distances between the categories may or may not represent a quantitative scale. It is contemplated that the center category, as well as the categories to the right and left may comprise different sets of ideas over time and over geographical regions. The calculation of a position on the horizontal dimension may be based on an algorithm utilizing several or all of the factors listed above. An exemplary algorithm may comprise initially assigning a source to a horizontal location based on answers to factor a (Percentage of news media stories falling within each partisanship category), and adjusting the placement right or left based on factors b-e.

In some embodiments, the calculations of a news source's placement may be expressed as a score on a numerical scale (e.g., 80 on a scale of 1-100 vertically, and +50 on a scale of −100 to +100 horizontally; embodiments shown in the Figures use a numerical scale of 0 to 64 vertically, and −42 to +42 horizontally). However, a numerical score does not necessarily need to be expressed in order to calculate a position on the chart. For example, a calculation may simply be expressed by placement in a particular category vertically and horizontally and adjusted up, down, right, or left based on the factors listed previously.

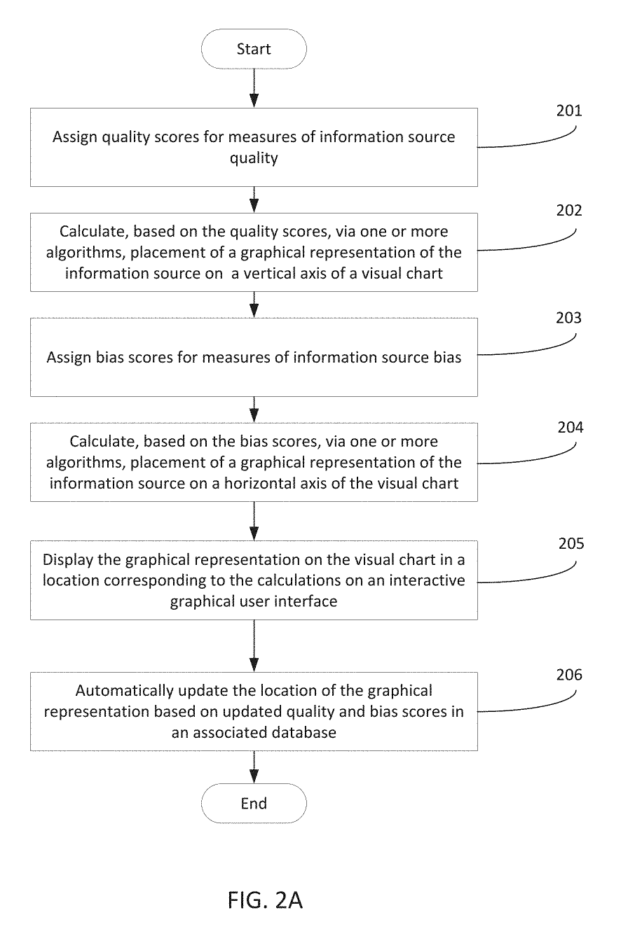

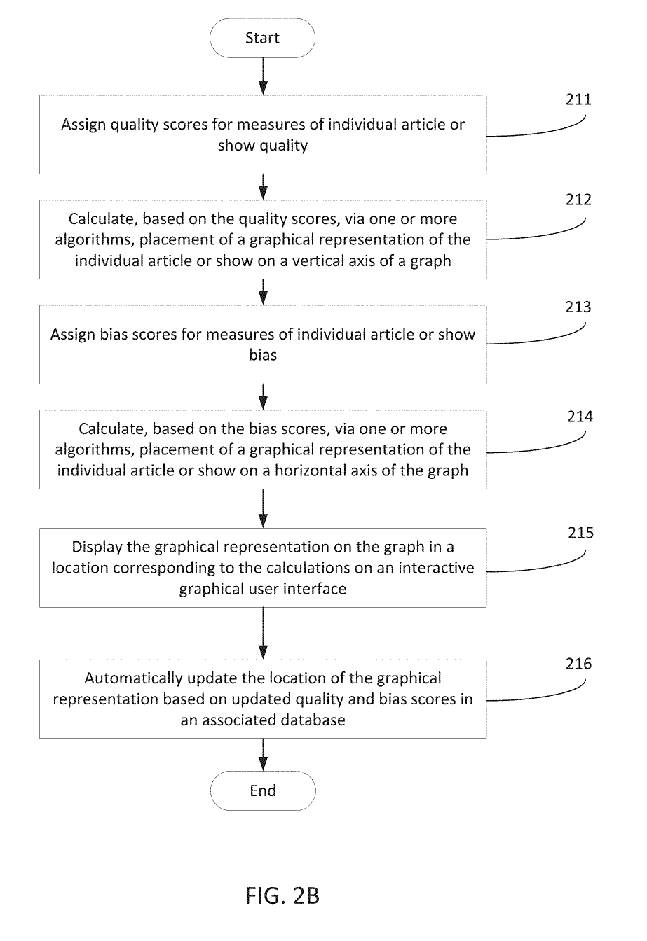

FIGS. 2A and FIG. 2B show exemplary methods that may be used to implement aspects of the disclosure. FIG. 2A shows steps 201-206 of a method 200 that may be implemented to rank information sources, and FIG. 2B shows steps 211-216 of a method that may be implemented to rank individual articles or stories. In embodiments, the method 210 of FIG. 2B may be implemented in conjunction with the method 200 of FIG. 2A, thereby ranking individual articles or stories as a part of ranking information sources.

An aspect of the disclosure is that the results of the calculations for vertical and horizontal placement of a source may be visually displayed on an interactive chart on a graphical user interface. As shown in FIG. 1, multiple sources may be displayed on a single chart 100. In embodiments, the position of the sources on the chart may be automatically updated based on updates to the one or more databases. For example, the database may be updated frequently with new measurements of percentages of stories that fall into the vertical and horizontal categories, and may be used to recalculate positions of the sources. If recalculated position values are different from previous values, then the corresponding visual ranking (i.e., vertical/horizontal placement) may be updated. It is contemplated that the database may be updated weekly, daily, hourly, or even more frequently, and that the recalculation and re-display may be updated at corresponding intervals. Historical entries into the database may be used to display how an information source's ranking has changed over time.

Other interactive features of the visual display may include, as previously discussed, an audience-size visualization display, wherein a user can hover over or click on a source to see its readership, viewership, TV ratings, or other measure of audience size. In some embodiments, this visualization may comprise a pop-up box displaying a number in text. In other embodiments, the visualization may comprise expanding a colored circle around a source name or logo. In such visualizations, it is contemplated that a benchmark size for the source with the largest audience may be set to have the largest circle when clicked or hovered over. In some displays, the image of the chart may be reduced in size (creating a “zoom out” effect) and the “audience size” circle may be expanded to overflow the edges of the chart. In some displays, the audience size circle may remain concentric with the positioning of the news source name or logo. Audience size circles for each source may be proportional in comparison to the benchmark largest circle for users to easily visualize comparative sizes between sources. A user may be able to hover over a circle and click on it to keep the circle displayed, and then hover over another circle and click it to keep it displayed simultaneously. In such displays, the other news source names or logos may remain their original size. In other displays, audience size circles may all be simultaneously displayed, with some grayed-out or translucent while in the background or not selected, and the sources of interest in brighter colors or brought to the front. Each of the above-described features are ways in which a graphical element of the chart may change upon a user interaction.

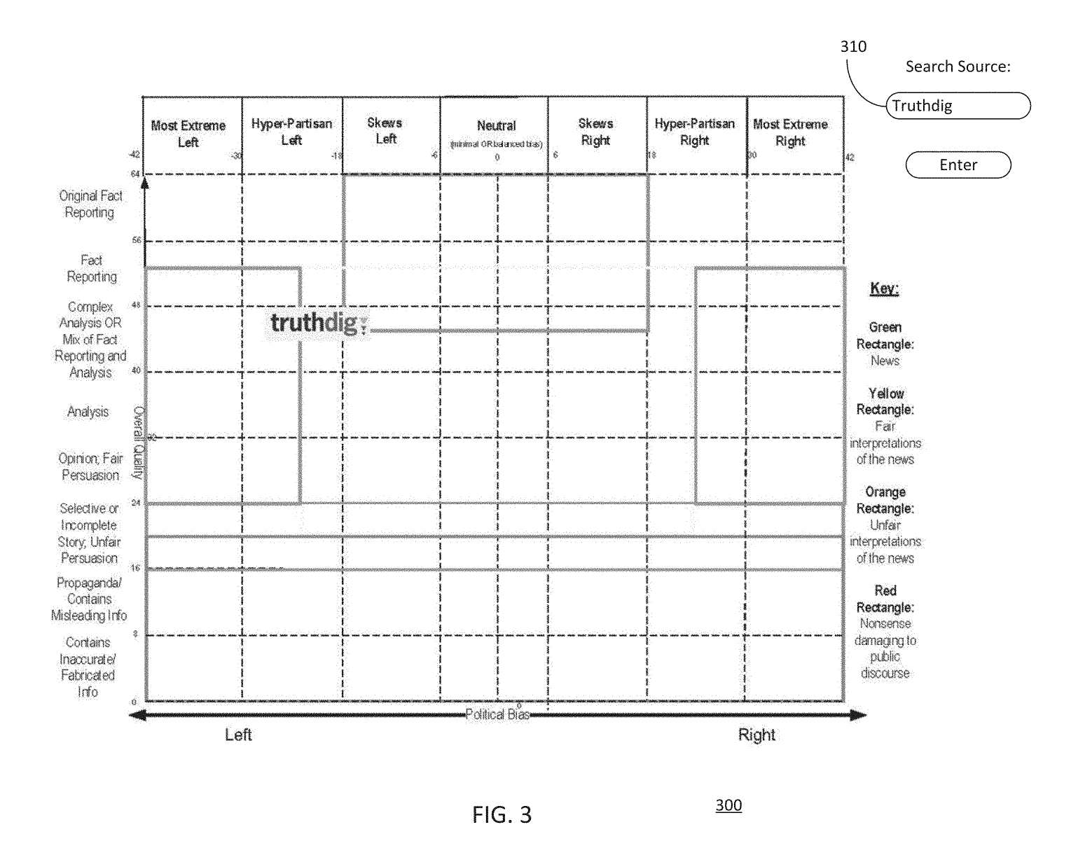

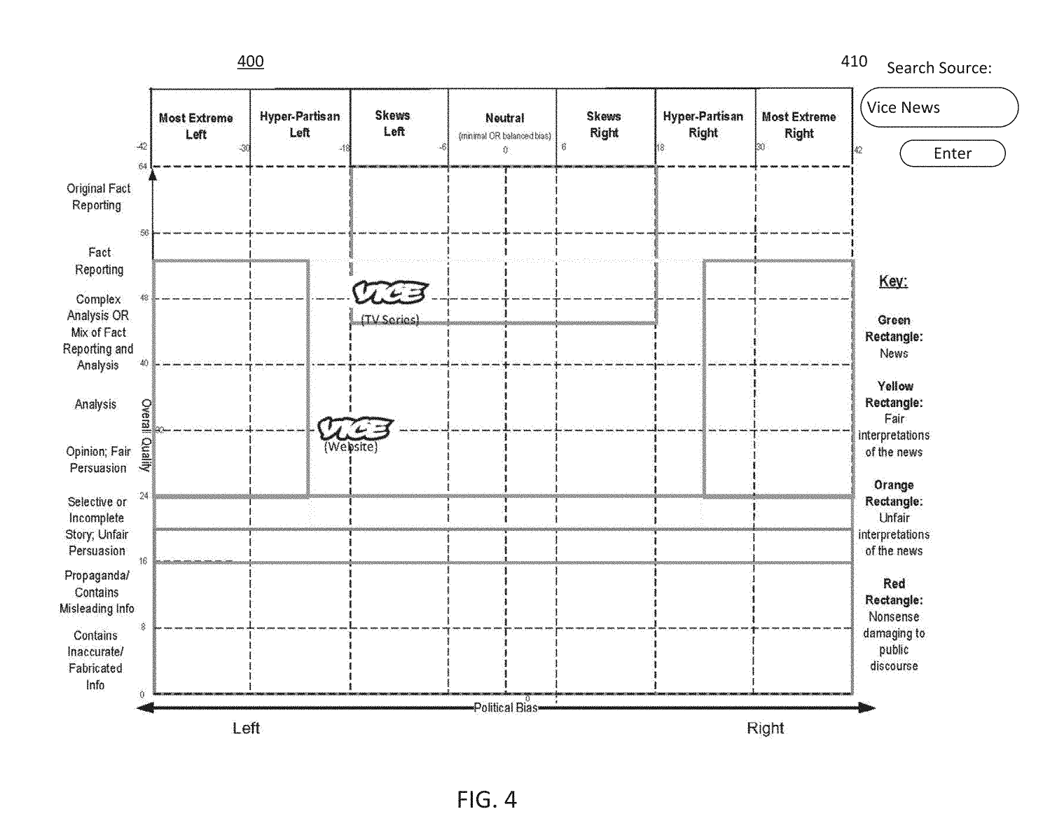

In some displays, a user may remove sources from the visual display of the chart in order to see sources of interest more easily. A user may do this in the audience size display or in any other display. A user may want to view a single source in isolation. Examples of these views are shown in FIGS. 3 and 4. FIG. 3 shows a single source that exists in an online website form, and FIG. 4 shows a single source that exists in both television and website formats. For sources that exist in multiple formats, embodiments of the system may provide rankings and displays that are distinct.

A user may arrive at the displays shown in FIGS. 3 and 4 in several ways. One way is to enter a name of a source in the search tools 310 and 410 associated with the interactive charts 300 and 400. This way may present a single source in isolation, or if the user prefers to still see where the source ranks in comparison to other sources, the single source may appear enlarged or in a bright color while other sources are grayed-out or made to appear translucent. In the embodiment shown in FIG. 4, a single source may itself be represented by more than one graphical representation when the information source has more than one distribution channel, and if the content in the distribution channels is of different quality and/or bias. In the example shown, the single information source has a television distribution channel and a website, and each are represented in different locations on the chart.

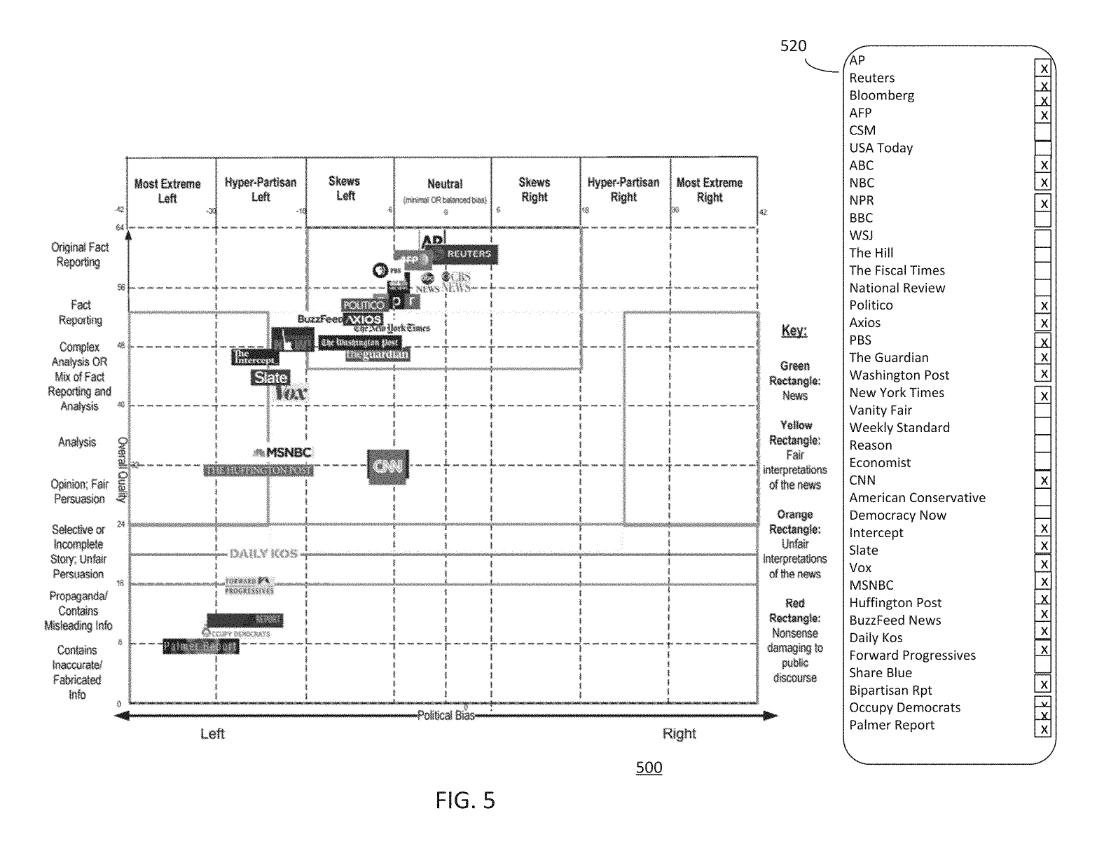

Another way a user may arrive at a display showing fewer than all the sources that are available is by selecting news sources from a list with checkboxes, as shown in FIG. 5. A user may wish to see such a display in order to get a tailored view of rankings of sources he or she relies on for news. In FIG. 5, the user may select from a selection list 520, which then displays selected news sources on the custom chart 500. A user may desire such a view to see trends in the quality and partisanship of news sources he or she often reads.

Yet other displays may be generated by how individual news media articles or stories are rated through the methods of the present disclosure. As previously discussed, one or more databases may comprise data on news sources, which may itself comprise information about overall characteristics that may be counted or otherwise measured by conventional data-gathering methods. This data on overall characteristics may include a number of stories or articles published per day, and audience size or ratings. The data on news sources may also comprise statistics calculated based on ratings of individual articles. For example, articles themselves may be ranked on a vertical dimension of quality and a horizontal dimension of partisanship, similarly to how the news sources are ranked. The information in the database may comprise total numbers of ranked articles that fall into each vertical and horizontal category. It may also comprise information on how the individual articles or stories were scored. This information may be used to calculate overall rankings or sources. In some displays, the numbers of articles that fall in particular categories may be used to calculate mean or median rankings. In others, certain articles may be weighted and use a unique formula to generate the overall source ranking. For example, a source's five most read or most shared stories may be weighted higher than any other stories. In some displays, only a source's most read or most shared stories may be used to rank the overall source.

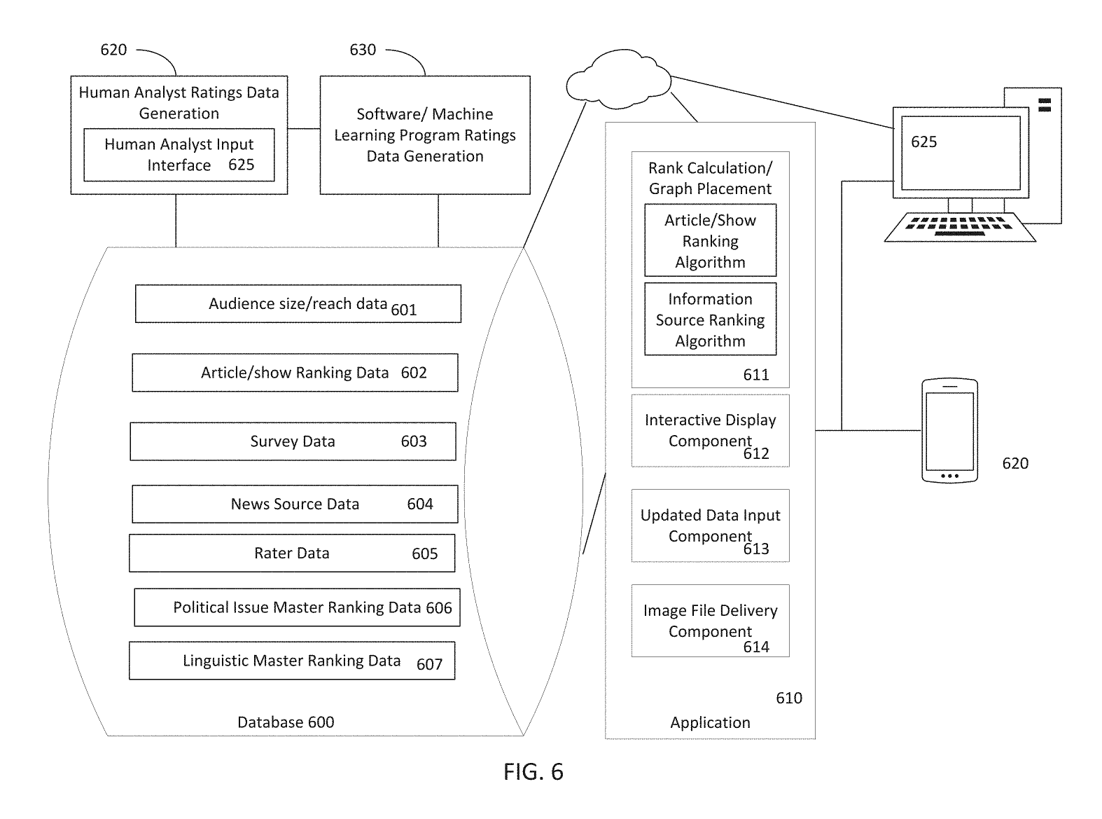

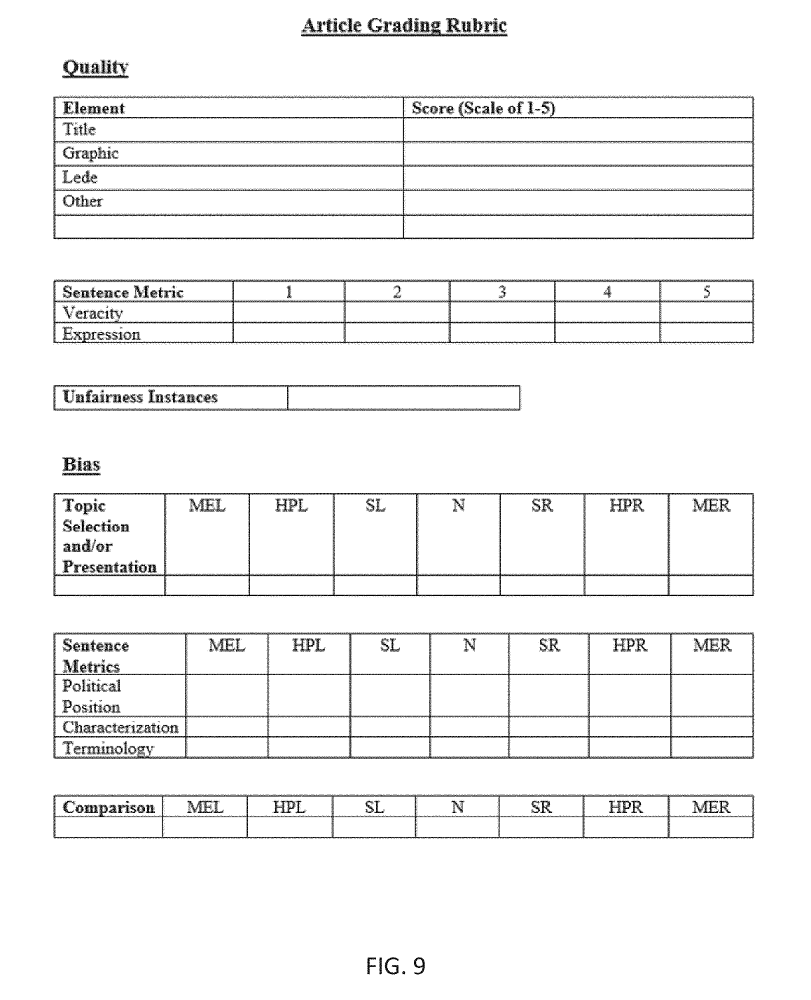

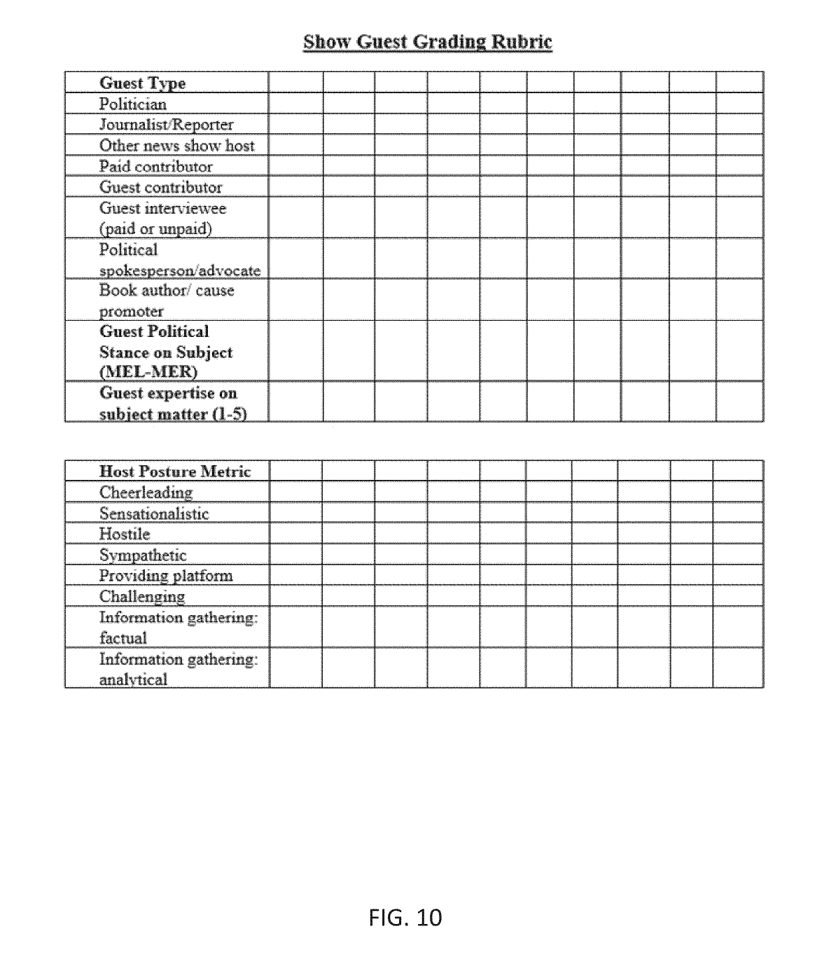

FIG. 6 is a logical block diagram illustrating a configuration of data generation components 620 and 630, a database 600, an application 610, a network 650, and computing devices 640 and 645 that may implement the system of the present disclosure. The components shown may be implemented in software, hardware, firmware, or a combination of hardware and software, and should not be construed as a hardware diagram. As shown, at least a portion of the data generated for input into the database 600 may be generated by human analysts, as illustrated by the human analyst ratings generation component 620. Human analysts may input data, including scores, via a human analyst input interface 625. Human analysts may use provide data according to the methods described with reference to FIGS. 9 and 10. Additionally or alternatively, data may be generated via a software and/or machine learning program ratings data generation component 630. Human analysts may work in conjunction with automated software, including machine learning programs, to generate ratings data. Data from the data generation components 620 and 630 may then be put the database 600. The database 600 may include data from other sources not shown as well. The database 600 may include audience size data 601 and article/show ranking data 602 (in many embodiments, from the data generation components 620, 630). The database 600 may also include survey data 603 (i.e., traditional consumer polls), and news source data 604 (such as numbers of journalists, years in existence, etc.). The database 600 may further comprise rater data 605, which may comprise information about the human analysts, such as their political leanings and professional training.

Another aspect of the disclosure is that the database may comprise data that may be used by the human analyst ratings data generation component 620 or the software/machine learning program ratings data generation component 630 to evaluate articles or shows themselves. This may include political issue master ranking data 606. Such data would include classifications matching particular political positions with ranking values for bias. The database may also include linguistic indicator master ranking data 607. Such data would include classifications matching linguistic indicators (i.e., specific words) with ranking values for bias and/or quality. It is contemplated that in embodiments the political issue master rankings data 606 and linguistic indicator master rankings data 607 may be used in at least two ways: 1) by raters to evaluate sources, and 2) to accept inputs from raters as they come across new political positions and words that are not already classified in the data sets 606, 607. The database may also comprise other data to be used as input to the application 610, and may be collected in any manner, such as through software or manually. The database 610 may reside on its own server in embodiments. The database 600, application 610, and computing devices 640 and 645 implementing the display system may all be connected via a network 650. The application 610 may use data from the database 600 as inputs to the functions of the application 610.

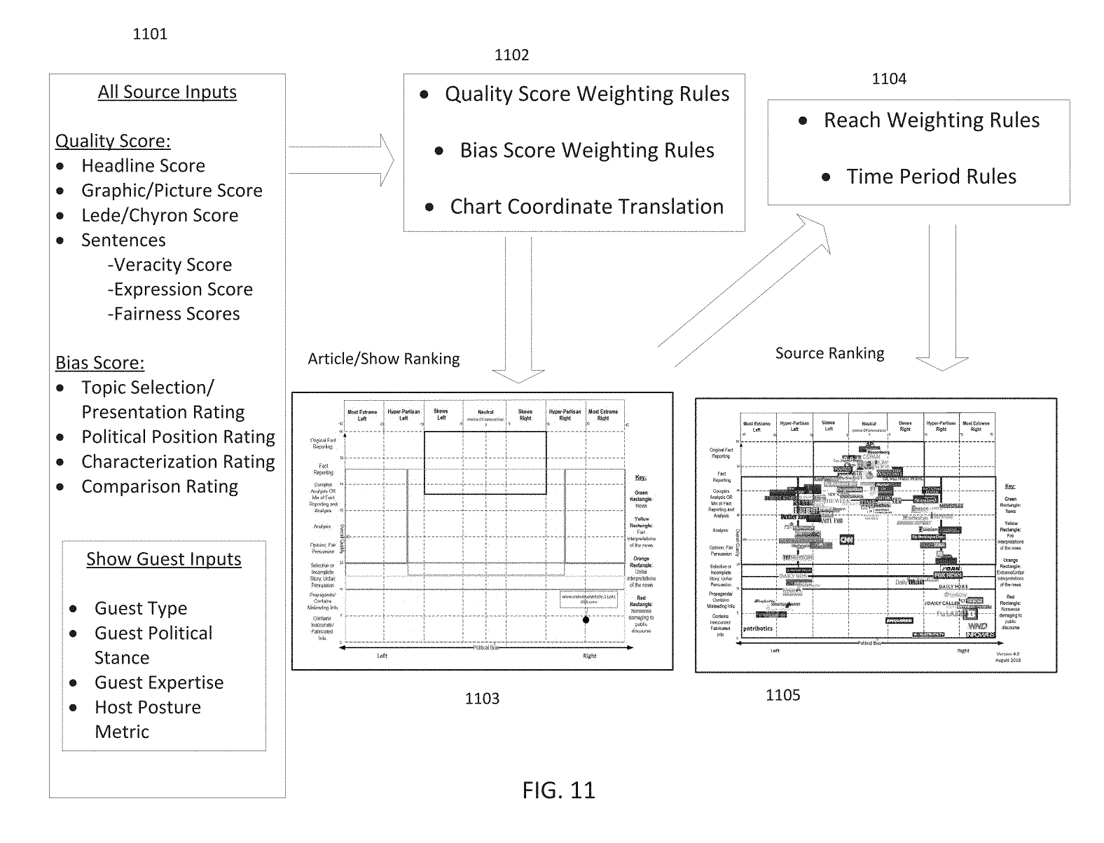

The application 610 may include a rank calculation component 611 which may itself include an article/show ranking algorithm 615 and an information source ranking algorithm 616. The algorithms 615, 616 will be described in more detail with reference to FIG. 11. The application 610 may include an interactive display component 612 for visually displaying graphical representations of articles, shows, or information sources. The application 610 may also include an updated data component 613 configured to automatically update placement of graphical representations based on changing data in the database 600. It may also comprise an image file delivery component 614.

The rank calculation component 611 may implement the algorithms described in this disclosure for determining where on a visual display to place a source or article. The interactive display component 612 may implement the changes, features, and functions of the graphical display on the computing devices 640 and 645. The application may also include a new story input component 617 may accept input from users on the computing devices 620 and 625 of hyperlinks or other article data that are to be submitted for evaluation by the system. The image file delivery component 614 may create portable, shareable, downloadable images, interactive files, audio, and video files for users based on their selections from the displays, which may allow a user to download a customized image, such as a PDF, .jpg, or other image file format, of the specific articles, shows, or articles displayed on the graphical user interface at a particular time. The application 610 may be implemented through software-as-a-service or may be downloadable. The application 610 may be implemented on a remote application server in some embodiments, and may be used on any computing device, including smartphones.

An aspect of the present disclosure is that individual articles and stories may be scored in detail according to particular algorithms and methods. These methods may rank quality and partisanship, or other dimensions on multiple factors. The methods for ranking for quality may include individually scoring titles, ledes (i.e., introductory sections of news stories), graphics, chyrons (i.e., banners appearing at the bottom of a television news broadcast), and individual sentences of the articles or stories. In many embodiments, each sentence may be rated on a plurality of scales. The methods for ranking for partisanship may include measures of each instance of characterization of a fact, and comparisons to other stories about the same or similar topic. The methods of the present disclosure provide analysis that is systematic and relies on characteristics of the most granular units of stories. One benefit of analyzing stories in this level of detail is that it is repeatable with a high level of consistency across different human coders. Another benefit is that it can be implemented in part by software, including machine learning software in some embodiments.

The method for ranking an individual story may comprise the following steps. First, the headline (or title) may be analyzed and rated on a scale of 1-10, with 1 being the highest quality and 10 being the lowest quality, for example. Other scales, such as 1-5, may also be used. The method may evaluate the headline based on one or more of the following criteria:
a. Presence of hyperbole;
b. Presence of adjectives; or
c. Quality of grammar, spelling, punctuation, capitalization, and font size.

Then the method may comprise reading the headline and looking at a graphic or photo associated with the title (if present), and creating a statement regarding what the evaluator (also referred to as a rater or analyst) expects the article to be about based on reading the article and graphic or photo. Then, the evaluator may read or scan the article and determine if the content in the article matches the evaluator's expected topic based on the title to create the following factor:
d. Whether the headline matches what the evaluator expected from the content of the article.

Then, the evaluator may use the factors to rate the headline within one of the vertical categories for quality.

Then, the evaluator may individually rate the graphics or photographs associated with the article. The main criteria by which the graphic or photograph may be evaluated is fairness. The fairness metric will be described further with respect to the method for analyzing sentences of an article, but factors that may be considered to rate an article on a fairness scale may include if the photograph is unnecessarily unflattering to the subject, irrelevant to the topic of the article, or misleading as to the subject of the photograph or the article.

The method may then comprise evaluating the lede, or introductory subheading of the article. The lede may be evaluated on similar bases as individual articles, as will be described presently. For television shows, chyrons may be evaluated similarly. It is contemplated that the ratings of the headline, graphic(s), and lede or chyron may be used in addition to ratings for sentences of the article or story and used to calculate an overall ranking. It is contemplated that these elements may be weighted more heavily than the text of the article itself, because these elements are often seen and read many times more than the articles themselves are read.

The method for ranking individual sentences may comprise rating each sentence on multiple scales. These scales may include a “veracity” scale, an “expression” scale, and a “fairness” scale. Each of these scales may comprise numerical values. In embodiments, the veracity scale may comprise numerical ratings of 1-5, the numerical ratings representing the following levels of veracity:

True and Complete

Mostly True/True but Incomplete

Mixed True and False

Mostly False or Misleading

False.

In other embodiments, more or fewer levels may be implemented, in order to refine the efficiency and consistency of scoring. For example, if more or fewer categories can be used to increase the rate at which evaluators can score an entire article, or increase the similarity with which different evaluators score the same article, such levels may be implemented.

The method for ranking individual sentences by quality may further comprise ranking each sentence on an “expression” scale. In embodiments, the expression scale may comprise numerical ratings of 1-5, the numerical ratings representing the following categories of expression:

(Presented as) Fact

(Presented as) Fact/Analysis (or persuasively-worded fact)

(Presented as) Analysis (well-supported by fact, reasonable)

(Presented as) Analysis/Opinion (somewhat supported by fact)

(Presented as) Opinion (unsupported by facts or by highly disputed facts).

The categories above include whether something is “presented as” fact, analysis, etc. This expression scale focuses on the syntax and intent of the sentence, but not necessarily the absolute veracity. For example, a sentence could be presented as a fact but may be completely false or completely true. It wouldn't be accurate to characterize a false statement, presented as fact, as an “opinion.” A sentence presented as opinion is one that provides a strong conclusion, but can't truly be verified or debunked, because it is a conclusion based on too many individual things. Including an expression scale provides a measure for evaluating a sentence beyond conventional fact-checking methods.

Yet another step for evaluating a sentence may include scoring a sentence on another scale, which may be known as a “fairness” scale. In some embodiments, the fairness scale may comprise a numerical rating, such as 1-5 or 1-10, similar to the veracity and expression scale. In other embodiments, the fairness scale may comprise a simple fair/unfair rating. Fairness may be scored on the presence or absence of several factors, including, but not limited to:

Not relevant to present story

Not timely

Ad hominem (personal) attacks

Name-calling

Other character attacks

Quotes inserted to prove the truth of what the speaker is saying

Sentences including persuasive facts but which omit facts that would tend to prove the opposite point

Emotionally-charged adjectives

Any fact, analysis, or opinion statement that is based on false, misleading, or highly disputed premises.

The method for evaluating individual articles may further include software-implemented measurements, such as total word counts and sentence counts, counts of particular words such as adjectives, counts of words in quotes, counts of hyperlinks or citations, counts of certain punctuation marks, and counts of words on customized search lists. These counts may be used in conjunction with other metrics to calculate quality scores. For example, the number of sentences with a certain rank on the veracity, expression, or fairness scales may be divided by total numbers of sentences to calculate an aspect of the overall article rating.

Once an entire article or story has been scored, the various scores may be used to calculate a position on the vertical dimension of the chart. The categories on the vertical axis may represent a range of scores within which a story may be scored to place the story in the category.

Another aspect of the method for ranking articles may comprise ranking them on a partisanship dimension. Evaluating partisanship of an article may comprise measuring certain factors that exist within the article and then accounting for context by counting and evaluating factors that exist outside of the article.

The method may first include measuring several factors within the article. First, each instance of characterization of a fact may be counted and rated on a partisanship scale from −5 to +5, with 0 being a non-partisan characterization and −5 and +5 representing the most extreme characterization. Then, the method may comprise counting words from a list of identified partisan words previously compiled. Such a list may be stored in the database (e.g., in the linguistic indicator master ranking data 607), and may include words associated with one political ideology or another. These words may be referred to as “partisan words.” For example, the list may comprise a list of “conservative words” such as “pro-life” or “death tax,” and a list of liberal words such as “pro-choice” and “estate tax.” The list may have partisan words added to it and deleted over time, reflecting that what comprises conservative and liberal ideas evolves over time. It is contemplated that different countries would have different partisan words on these lists. Then, the method may comprise reviewing the counted partisan words for words that would ordinarily be used to promote one side's idea, but because of the context, were actually used not to promote, or to actively refute, that side's idea. For example, if the partisan word was used sarcastically, or with a negating word, the context would indicate that the word does not promote the side's idea. In embodiments of the method, during review, the reviewer would delete instances of partisan words on the list from the count of partisan words. In other embodiments, these instances may be used in other measures of partisanship.

The method for assessing partisanship of an article may then comprise an evaluator identifying the presence of partisan topics in the article, if any. These topics may be derived from a list of partisan topics, which, like the list of partisan words, may be added to and removed from over time to reflect that what constitutes liberal and conservative ideas evolves over time. The presence of partisan ideas may be derived from words describing such topics in the article, title, graphics, or headline itself. The partisan topics list may define what a mainstream conservative position and a mainstream liberal position on the topic. This list may be stored in the database 600 (e.g., in the political issue master ranking data 606). An evaluator may initially rate the article based on the topics within the article in comparison to the mainstream conservative and liberal positions on the partisan topic list.

Often, the strongest indicators of partisan bias are derived from the context in which the article or story appears, and from what is not in the article or story. It is difficult to measure what is missing in an article or story, but the present disclosure provides a method for measuring these aspects in a way that is defined and repeatable. The method for measuring the partisan bias may therefore include identifying a plurality of articles from other sources (referred to herein as “lateral articles”) about a similar topic. This step may comprise identifying a minimum number of articles, such as three, five, or ten, but other minimum numbers may be used. The method may comprise identifying, among the lateral articles a “benchmark” article that has the least partisan bias. The method may also comprise identifying two “most extreme” reference articles on each partisan side. It is contemplated that rules may be implemented for what articles may be used as lateral articles, which may include a time period within which articles may be compared.

The method may then comprise identifying any major facts omitted in the article being rated that are present in the lateral articles, the omission of which impacts the partisan viewpoint of the article being rated. The method may also comprise identifying other partisan topics that the article alludes to or are present as a side issue. The presence of these topics and their comparison to the partisan topic list may also be used as a factor to rate the article along the partisanship dimension. In some embodiments, the method for measuring partisan bias may include determining where the source of the article is ranked for partisanship on the partisanship dimension of the scale. This may be a relevant factor because allusion to partisan side topics may be important when the intended audience of the article is expected to have a partisan leaning one way or another. For example, if a source is known to lean conservative, and is covering an issue about immigration, the allusion to side issues such as taxes or crime may be flashpoints for the audience and should be considered in the partisan ranking.

In some instances, evaluating lateral sources may reveal unusual circumstances that may also be used to adjust a ranking on a quality or partisanship dimension. Journalism is a field that provides widespread and immediate peer review. Journalists, in general, read and respond to articles by other journalists, and when certain articles or stories make egregious departures from journalistic norms, they are often called out immediately. When a particular article or story becomes so notorious that the article or story itself becomes news, the reasons why maybe used to adjust the ranking along one or more of the dimensions. For example, if it is revealed that the publication of a story violated an ethical rule of journalism, such as publishing a rumor without verifying it, or if a low-quality opinion piece is published in a normally high-quality publication, or if a piece omits so much context that it is tone-deaf to important current cultural issues, such circumstances may be used to adjust an overall ranking.

The above method for evaluating partisanship requires several subjective judgment calls by human evaluators, but may be used over time to provide input to artificial intelligence and machine learning algorithms that can make these judgment calls with a high level of confidence. In order to validate and assess the credibility of the above methods with the public, politically balanced panels of individuals (e.g., a panel of five individuals knowledgeable about politics and news, including two self-described liberals, two self-described conservatives, and one self-described centrist) may be used to provide subjective ratings of such articles for comparison.

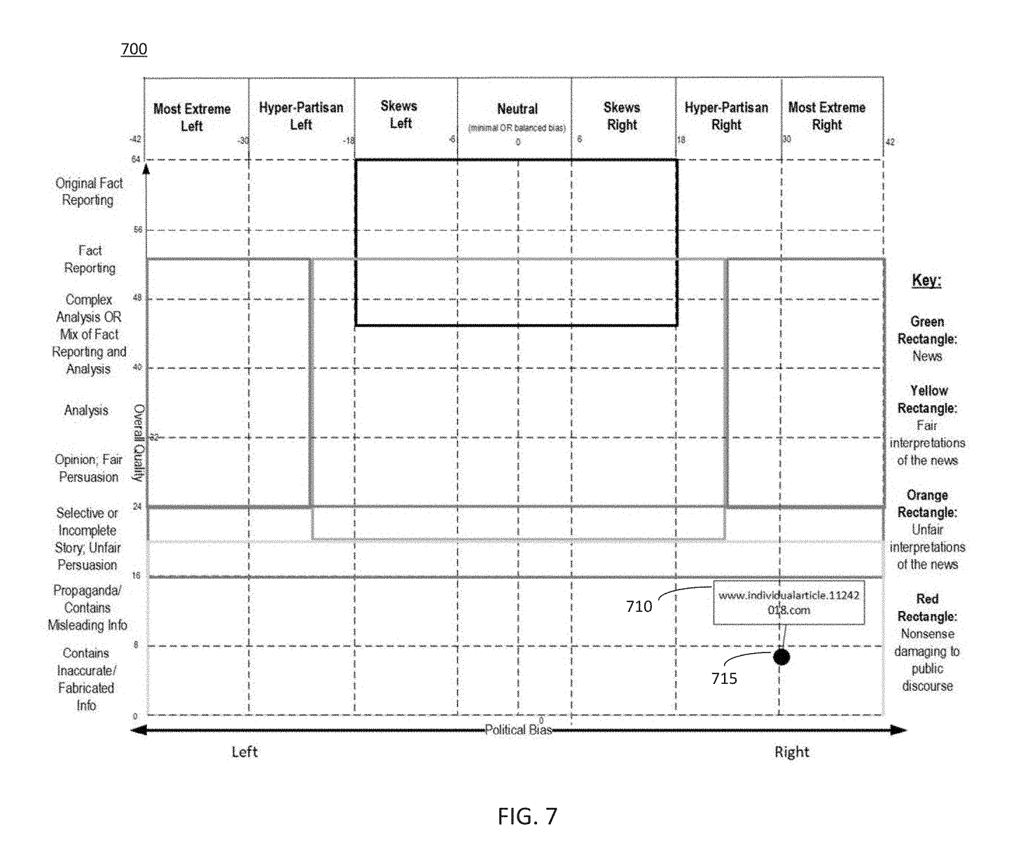

Once the partisanship of the article or story has been scored, it may be displayed on the chart as a function of its quality score and partisanship score. An individual article may be displayed on the interactive chart with a hyperlink to the article. FIG. 7 shows an exemplary display of an individual article with a hyperlink. As shown, the single article display 700 shows an individual article 710 surrounded by a color-coded border 715 (e.g., red), which may indicate that the article falls within a particular color-coded section of the chart. The hyperlink may take the user to the article itself. In embodiments, when a user hovers over the article icon, a small menu may pop up, providing two options for where a user wants to go. One option may be to go to the article, and the other option may be to go to a detail page that discusses the article rating.

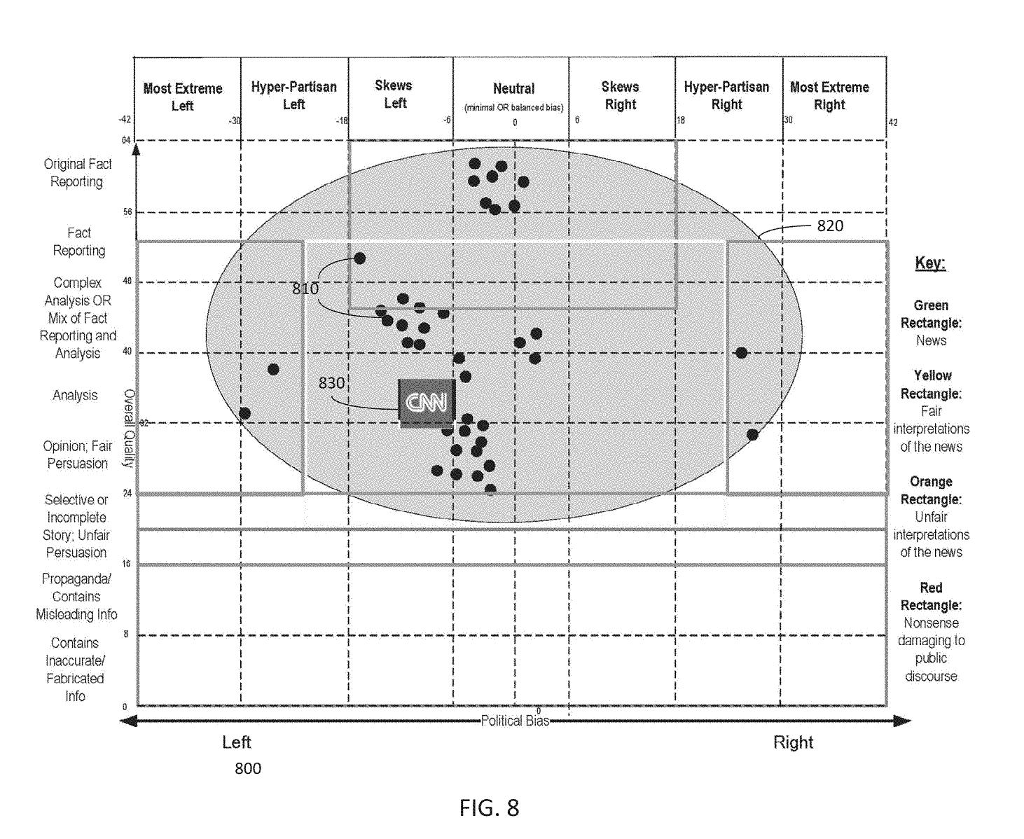

Another display may combine a view of ratings of multiple individual articles of a single source, the overall range of article quality and partisanship, and the ranking of the source, as shown in FIG. 8. This display may be referred to as a “scatter graph” view, and may also be interactive. The display 800 shows several dots 810 which represent individually ranked articles, a range indicator 820, which shows the range of the individually ranked articles, and a logo of the source 830. The display 800 may be interactive and allow a user to hover over each of the dots 810, which may show more information about the article, such as the headline and date, as well as a pop-up menu like the one described with reference to FIG. 7.

In embodiments, one or more of the displays described herein may include a search function to allow users to find single sources and single rated articles. They may also include request input forms that allow a user to enter the name of a source or a website link to a source or an article to request new ratings on the display. In some embodiments, where an article has been previously rated or software is used to evaluate articles quickly, the new rating may appear immediately.

Another feature of the display is that a portable image file, such as a .jpg, .pdf, .png, .gif, or audio or video file may be obtained by a user. In some embodiments, the image file may be interactive. A user may request an image file of a display or part of a display that the user is currently viewing, and the file may be downloadable or shareable. It is contemplated that users may share these images, which show ratings of news sources and stories, in response to users posting certain stories on social media feeds. In some embodiments, color-coding schemes or symbols may be used to represent where a story or article would be ranked on the chart. It is contemplated that sites displaying news may have these color-coding schemes or symbols integrated with their displays to show where articles or stories would be ranked without having to leave the site. Some embodiments may utilize paid subscriptions to provide certain features described herein.

Embodiments of the disclosure may include additional methods of rating and algorithm translation. An aspect includes having a team of people with differing political views trained on the following ratings standards, and using multiple raters on particular articles to allow averaging of scores to minimize effects of bias. In embodiments, this ratings process may be automated and scaled up via machine learning forms of artificial intelligence. Part of this scaling-up automation process may include quality checking the AI results against subjective ratings by humans to ensure the scoring and algorithms produce results consistent with human judgments. For example, the same article may be subjectively rated on the chart by a panel of three humans, one who identifies as fairly right, one who identifies as fairly left, and one who identifies as centrist. These three ratings may be averaged for an overall subjective ranking, and a machine scored article would have to match that average ranking.

There are different, additional criteria that go into rating TV shows as compared to written articles. This disclosure first discusses the article rating methodology because the show rating methodology may use the article rating methodology as a first step and add additional show ranking criteria, which mostly deals with the quality and purpose of show guests. Exemplary rubrics for both article grading and show grading are shown in FIGS. 9 and 10, respectively.

The first of article ranking may comprise a step of rubric grading. FIG. 9 shows an article grading rubric that may be used for full rankings of articles. As shown, there are two main parts, one for a quality score and one for a bias score.

Quality rankings may comprise assigning element scores. Each element may be scored on a scale of 1-5, which may be translated to the vertical values on the chart. Then Sentence scores may comprise rating each sentence is rated for both Veracity (1 being completely true and 5 being completely false) and Expression (1 being a fact statement and 5 being an opinion statement). Hash marks may be placed under each 1-5 category for each sentence and the total each category may be summed. Then a number of unfairness instances for the whole article may be counted.

Bias rankings may comprise rating Topic Selection and/or Presentation. The topic itself, and how it is initially presented in the headline, may be categorized in one of the seven horizontal categories on the chart (MEL=Most Extreme Left, HPL=Hyper-Partisan Left, etc.). This is one of the ways to measure bias by omission. Here, a topic may be categorized in part by what it means that the source covered this topic as opposed to other available topics covered in other sources.

Bias rankings may further comprise Sentence Metrics. Not every sentence contains instances of bias related to the three types listed here, which are biases based on “political position,” “characterization,” and “terminology.” Sometimes these instances overlap. Each one throughout the article is counted.

Bias rankings may also comprise a Comparison score. The overall bias is scored in comparison to other known articles about the subject. This is a second way bias by omission may be measured. Comparison may be done in view of other contemporaneous stories about the same topic, and bias can be determined in view of all the possible facts that could reasonably be covered in a story.

The ranking method may then comprise Step 2: Algorithm Translation, in which the raw scores are then input into an algorithm that weights certain categories of scores and averages them, and then translates those weighted average scores into coordinates on the chart (e.g., 48, −18). The exact weighting formulas may vary, but as an example of some of the effect of the weighting decisions, consider an article that has 20 sentences, and on the Veracity scale (how true each sentence is), 14 of the sentences are 1's (completely true), 4 sentences are 3's (neither true nor false) and 2 sentences are 5's (completely false). A straight average would give this a Veracity score of 1.8 (mostly true) on this scale, which would generate a bad result because an article containing two completely, demonstrably false statements is typically viewed as very low quality according to journalism standards. Therefore, any Veracity “5” scores may be weighted very heavily.

Not all algorithm weighting decisions may be so extreme, and some may be calculated as a straight average. For example, on the Expression scale, an article that has an equal number of 1's (stated very factually) and 3's (stated as analysis) would likely get an Expression score of 2 (stated factually with some analysis). There are many relationships between different raw scores on the rubric that get translated in the algorithm.

Regarding how these scores are translated onto the coordinates on the chart, a number of different raw scores may result in placements in the different categories. For example, a source that has a lot of foul language used to characterize political opponents would have high raw scores in the “unfairness instances” metric and “characterization” metric in the “Most Extreme” columns, which would result in its placement in the low bottom right or left under “Propaganda/Contains Misleading Info.” This could be the case because the content is categorized in this system as “propaganda,” even if the content was not misleading. That is, it may not have any completely false statements (no Veracity “5's”). Conversely, a different article from a different source may be placed in a similar spot on the chart because it has several Veracity “4's,” and Expression “4's,” even though it does not have high raw scores for the unfairness instances or extreme characterization metrics.

Another aspect of the present disclosure includes a Show Rating method. A first step may comprise rubric grading according to the rubric shown in FIG. 10. Grading TV shows (or video, e.g., YouTube shows) involves grading everything according to the Article Grading Rubric of FIG. 9 but also adds the Show Grading Rubric shown below.

There are several major format differences between articles and shows, the first of which is that there are many more visual elements (titles, graphics, ledes, and chyrons), each of which may be scored. The second is that a major component of most cable news shows are guest interactions, which is what the show grading rubric measures. In the system of the present disclosure, each of the Type, Political Stance, and Subject Matter Expertise of each guest, as well as the Host Posture towards each guest may be rated. In some embodiments, each of these measures may be scored by humans, and in others, human scores may be used as inputs to a machine learning program, which may then automatically score each of these elements based on previously inputted human scores. Although at first glance, many cable news shows seem to follow the same format, these guest metrics provide the greatest insight into the differences in quality and bias between shows.

The rubric in FIG. 10 helps distinguish between networks and why certain ones such as Fox and MSNBC (or Fox and CNN) are not at similar places on opposite sides of the chart. A first aspect of the show rating method includes rating Guest Type. “Guest” is a term for anyone who appears on the show who is not a host. These guests can be called any number of titles depending on the show. They can include on-site reporters, who report in a traditional style seen on network evening news programs or local new programs, but a large number of guests on cable news shows are commentators, and are called “contributors,” “analysts,” “interviewees,” etc. Many shows commonly have up to ten such guests per show. In the embodiment shown, there are ten columns on the rubric for ten guests. More or fewer may be used. Of the guest types listed (politician, journalist, paid contributor, etc.), none are necessarily indicative of quality of bias on their own. Quality and bias of guest appearances may instead be determined by the “guest type” in conjunction with each of the other metrics for each guest.

The show ratings may include a Guest Political Stance on Subject. A guest's political stance on a particular subject, if known or described during the guest appearance, is rated according to the horizontal scale (Most Extreme, Hyper-partisan, Neutral, etc.). One aspect of rating the stance of the guest within the system of the present disclosure is that ratings may be made on the particular issue at the particular time of the appearance, rather than on a stance based on a person's historical or reputational affiliation, or a broad categorization of a person's political leanings, which is a less accurate basis for rating bias of a guest appearance. That is, it is less accurate to say, “this person is liberal (or conservative)” than to say, “this person took this liberal (or conservative) stance at this time.” People and their histories are complex.

For politicians, political stances on particular issues are often publicly available information via their platform or other statement of issues on their websites, and their historical/reputational stances are often the same as their stances during a particular appearance. However, it is especially important to distinguish between a guest's current stances and past affiliations, particularly during times of rapid change in politics. For example, if the current Governor of Ohio, John Kasich, appears on a show and fairly criticizes President Trump for a particular statement or action, such a stance should be rated as neutral or skews left, instead of using his party affiliation (Republican) to rate his stance as skews right. However, if he was talking about his positions on abortion or taxes, his stance would likely be rated as skews right (based on such stated right-leaning positions on Kasich' s website).

The show rating may also include rating Guest Expertise on Subject Matter. This rating takes into account both the expertise of the guest as well as the subject matter about which the guest is asked to speak. An “expert” does not necessarily have to have particular titles, degrees, or ranks. Rather, “expertise” is defined here as the ability to provide unique insight on a topic based on experience. Although many guests have expertise and a title, degree, and/or rank, others have expertise by virtue of a particular experience instead. For example, an ordinary person who has experienced addiction to opioids may have expertise on the subject of “how opioid addiction can affect one's life.” We can refer to this type of expert as an “anecdotal” expert. However, that same person may or may not have expertise on the related subject “what are the best ways to address the opioid epidemic,” and a different kind of expert may be a physician or someone with public health policy experience. We can refer to such an expert as a “credentialed” expert.

As shown in FIG. 10, Expertise may be rated on a scale of 1-5, as follows:
1: Unqualified to comment on subject matter
2: No more qualified to comment than any other avid political/news observer on political/news topic
3: Qualified on ordinarily complex topic or common experience
4: Qualified on very complex topic/Very qualified on ordinarily complex topic/Qualified on uncommon experience
5: Very qualified on very complex topic/Very qualified on very uncommon experience.

As shown in FIG. 10, Host Posture Metric may also be measured. The interaction between the guest and the host also impacts the bias of the guest appearance. For example, the bias present when a host is challenging a hyper-partisan guest is very different than the bias present when another host is sympathetic with the same hyper-partisan guest. The scale, as shown in FIG. 10, identifies several types of host postures, each of which are fairly self-explanatory. They are somewhat listed in order of “worst” to “best,” but some postures, such as “challenging,” or “sympathetic” are not necessarily good or bad, and determinations of bias depend on the context.

An embodiment of the algorithm translation method of the disclosure is shown in FIG. 11. In some embodiments, sub-charts showing rankings of individual articles, or individual shows of a particular source or network, may be displayed to users. As shown, many inputs 1101, created from human-scored or machine-scored individual element scores based on the rubrics shown in FIGS. 9 and 10, may be entered in to an individual article or show rating algorithm 1102. The individual article or show rating algorithm 1102 may implement several rules, including quality score weighting rules and bias score ratings rules. An aspect of the present disclosure is the chart coordinate translation algorithm which takes raw scores from the scoring rubrics and mathematically translates them to coordinate places on the x-axis and y-axis of the interactive graph 1103.

Each of the individual article or show rankings placed on the chart 1103 may now have an associated chart coordinate position, which may itself be input into the overall information source ranking algorithm 1104, which itself has rules such as reach weighting rules and time period rules. Alternatively or additionally, original inputs 1101 may be input into the information source ranking algorithm 1104. The rules of the information source ranking algorithm may be used to place a graphical representation of an overall information source on the interactive graphical user interface chart display. The individual article or show ranking algorithms 1102 and the overall information source ranking algorithm 1104, may be referred to as the graph placement algorithms. The graph placement algorithms 1102, 1104 may be implemented in a ranking application, which may be implemented in software, hardware, or a combination of software and hardware. The ranking application may provide and/or be implemented via an interface between one or more databases of the system and the interactive graphical user interface display.

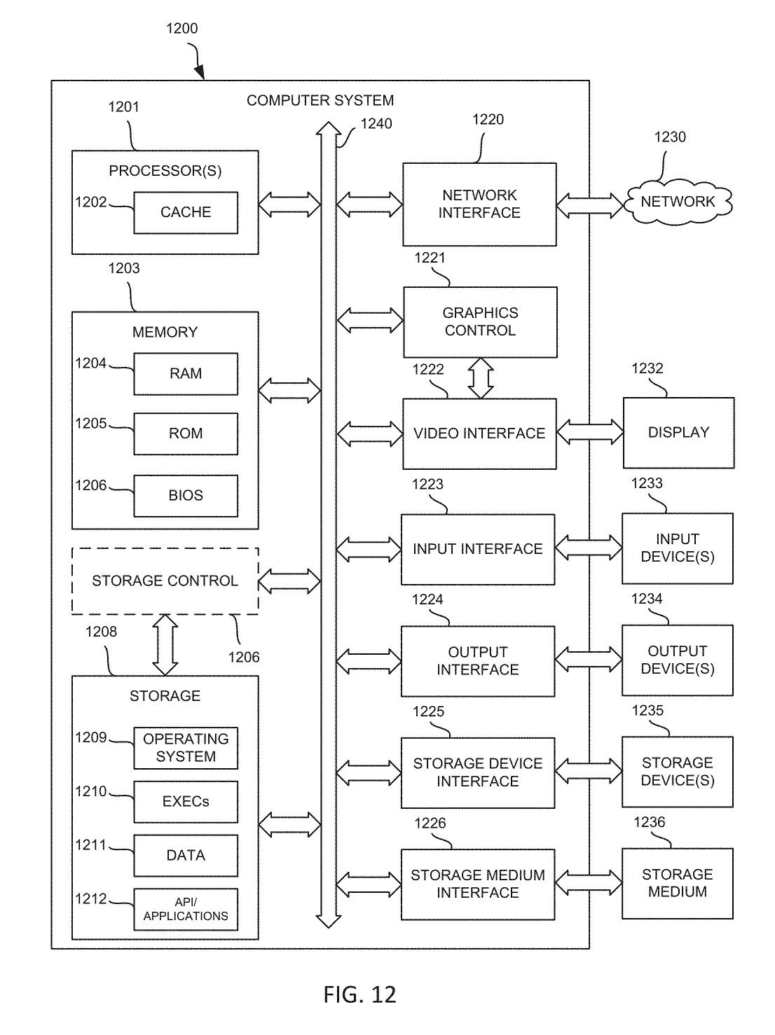

Referring now to FIG. 12, it is a block diagram depicting an exemplary machine that includes a computer system 1200 within which a set of instructions can execute for causing a device to perform or execute any one or more of the aspects and/or methodologies of the present disclosure. The components in FIG. 12 are examples only and do not limit the scope of use or functionality of any hardware, software, embedded logic component, or a combination of two or more such components implementing particular embodiments.

Computer system 1200 may include a processor 1201, a memory 1203, and a storage 1208 that communicate with each other, and with other components, via a bus 1240. The bus 1240 may also link a display 1232, one or more input devices 1233 (which may, for example, include a keypad, a keyboard, a mouse, a stylus, etc.), one or more output devices 1234, one or more storage devices 1235, and various tangible storage media 1236. All of these elements may interface directly or via one or more interfaces or adaptors to the bus 1240. For instance, the various tangible storage media 1236 can interface with the bus 1240 via storage medium interface 1226. Computer system 1200 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1201 (or central processing unit(s) (CPU(s))) optionally contains a cache memory unit 1202 for temporary local storage of instructions, data, or computer addresses. Processor(s) 1201 are configured to assist in execution of computer readable instructions. Computer system 1200 may provide functionality for the components depicted in FIG. 1 as a result of the processor(s) 1201 executing non-transitory, processor-executable instructions embodied in one or more tangible computer-readable storage media, such as memory 1203, storage 1208, storage devices 1235, and/or storage medium 1236. The computer-readable media may store software that implements particular embodiments, and processor(s) 1201 may execute the software. Memory 1203 may read the software from one or more other computer-readable media (such as mass storage device(s) 1235, 1236) or from one or more other sources through a suitable interface, such as network interface 1220. The software may cause processor(s) 1201 to carry out one or more processes or one or more steps of one or more processes described or illustrated herein. Carrying out such processes or steps may include defining data structures stored in memory 1203 and modifying the data structures as directed by the software.

The memory 1203 may include various components (e.g., machine readable media) including, but not limited to, a random-access memory component (e.g., RAM 1204) (e.g., a static RAM “SRAM”, a dynamic RAM “DRAM, etc.), a read-only component (e.g., ROM 1205), and any combinations thereof. ROM 1205 may act to communicate data and instructions unidirectionally to processor(s) 1201, and RAM 1204 may act to communicate data and instructions bidirectionally with processor(s) 1201. ROM 1205 and RAM 1204 may include any suitable tangible computer-readable media described below. In one example, a basic input/output system 1206 (BIOS), including basic routines that help to transfer information between elements within computer system 1200, such as during start-up, may be stored in the memory 1203.

Fixed storage 1208 is connected bidirectionally to processor(s) 1201, optionally through storage control unit 1207. Fixed storage 1208 provides additional data storage capacity and may also include any suitable tangible computer-readable media described herein. Storage 1208 may be used to store operating system 1209, EXECs 1210 (executables), data 1211, API applications 1212 (application programs), and the like. Often, although not always, storage 1208 is a secondary storage medium (such as a hard disk) that is slower than primary storage (e.g., memory 1203). Storage 1208 can also include an optical disk drive, a solid-state memory device (e.g., flash-based systems), or a combination of any of the above. Information in storage 1208 may, in appropriate cases, be incorporated as virtual memory in memory 1203.

In one example, storage device(s) 1235 may be removably interfaced with computer system 1200 (e.g., via an external port connector (not shown)) via a storage device interface 1225. Particularly, storage device(s) 1235 and an associated machine-readable medium may provide nonvolatile and/or volatile storage of machine-readable instructions, data structures, program modules, and/or other data for the computer system 1200. In one example, software may reside, completely or partially, within a machine-readable medium on storage device(s) 1235. In another example, software may reside, completely or partially, within processor(s) 1201.

Bus 1240 connects a wide variety of subsystems. Herein, reference to a bus may encompass one or more digital signal lines serving a common function, where appropriate. Bus 1240 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1200 may also include an input device 1233. In one example, a user of computer system 1200 may enter commands and/or other information into computer system 1200 via input device(s) 1233. Examples of an input device(s) 1233 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 1233 may be interfaced to bus 1240 via any of a variety of input interfaces 1223 (e.g., input interface 1223) including, but not limited to, serial, parallel, game port, USB, FIREWIRE, THUNDERBOLT, or any combination of the above.

In particular embodiments, when computer system 1200 is connected to network 1230, computer system 1200 may communicate with other devices, specifically mobile devices and enterprise systems, connected to network 1230. Communications to and from computer system 1200 may be sent through network interface 1220. For example, network interface 1220 may receive incoming communications (such as requests or responses from other devices) in the form of one or more packets (such as Internet Protocol (IP) packets) from network 1230, and computer system 1200 may store the incoming communications in memory 1203 for processing. Computer system 1200 may similarly store outgoing communications (such as requests or responses to other devices) in the form of one or more packets in memory 1203 and communicated to network 1230 from network interface 1220. Processor(s) 1201 may access these communication packets stored in memory 1203 for processing.

Examples of the network interface 1220 include, but are not limited to, a network interface card, a modem, and any combination thereof. Examples of a network 1230 or network segment 1230 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1230, may employ a wired and/or a wireless mode of communication. In general, any network topology may be used.

Information and data can be displayed through a display 1232. Examples of a display 1232 include, but are not limited to, a liquid crystal display (LCD), an organic liquid crystal display (OLED), a cathode ray tube (CRT), a plasma display, and any combinations thereof. The display 1232 can interface to the processor(s) 1201, memory 1203, and fixed storage 1208, as well as other devices, such as input device(s) 1233, via the bus 1240. The display 1232 is linked to the bus 1240 via a video interface 1222, and transport of data between the display 1232 and the bus 1240 can be controlled via the graphics control 1221.

In addition to a display 1232, computer system 1200 may include one or more other peripheral output devices 1234 including, but not limited to, an audio speaker, a printer, and any combinations thereof. Such peripheral output devices may be connected to the bus 1240 via an output interface 1224. Examples of an output interface 1224 include, but are not limited to, a serial port, a parallel connection, a USB port, a FIREWIRE port, a THUNDERBOLT port, and any combinations thereof.

In addition or as an alternative, computer system 1200 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An interactive display system for visualization of data quantifying information source quality and information source bias, the display system comprising:
an interactive graphical user interface application displaying:
a graph having at least two axes, the axes comprising:
a y-axis representing measures of the information source quality; and
an x-axis representing measures of the information source bias;
at least one graphical representation of an information source;
one or more databases comprising information source quality data and information source bias data about the information source represented by the at least one graphical representation on the graph, the one or more databases configured to provide the information source quality data and information source bias data to the interactive graphical user interface application;
a ranking application configured to:
automatically place, based on the information source quality data, the information source bias data, and a graph placement algorithm, the graphical representation at a particular coordinate position placement on the graph; and
automatically update, based on at least one of new information source quality data and new information source bias data, the coordinate position placement of the graphical representation,
wherein one or more graphical elements changes visually upon a user interaction with the one or more graphical elements.

2. The interactive display system of claim 1,
wherein the one or more databases further comprises:
individual article ranking data or individual show ranking data; and
wherein the interactive graphical user interface is configured to:
display, upon a user clicking on the graphical representation of the information source, a graphical representation of an individual article or an individual show.

3. The interactive display system of claim 2, wherein the display of the graphical representation of the individual article or the individual show is based upon individual article or show quality data, individual article or show bias data, and an individual article or show graph placement algorithm.

4. The interactive display system of claim 1, wherein the database further comprises:
reach data, wherein reach data comprises one or more of:
television ratings;
print circulation;
internet traffic; and
social media followings.

5. The interactive display system of claim 4, further configured to display a reach data graphic representing reach data associated with the information source.

6. The interactive display system of claim 2, wherein the display is configured to display a plurality of graphical representations of individual articles and/or individual shows at a plurality of coordinate positions on the graph upon a user clicking on the graphical representation of the individual source.

7. The interactive display system of claim 6, wherein the plurality of coordinate positions associated with the plurality of individual articles or shows comprise individual article and/or show rankings, and the graph placement algorithm uses the individual article and/or show rankings to determine the particular coordinate placement of the graphical representation of the information source.

8. The interactive display system of claim 1, wherein the information source comprises one of:
a website;
a newspaper;
a magazine;
a television news network; and
a news wire service.

9. The interactive display system of claim 4, wherein the automatic placement by the ranking application is further based upon the reach data.

10. The interactive display system of claim 1,
wherein the database further comprises a plurality of different historical entries for individual source quality data and a plurality of different historical entries for individual source bias data; and
wherein the graphical user interface is configured to display the graphical representation of the information source upon a plurality of historical coordinate positions on the graph based on the plurality of different historical entries for individual source quality data and a plurality of different historical entries for individual source bias data.

11. The interactive display system of claim 10, wherein the plurality of historical coordinate positions are displayed as the result of a user interaction.

12. The interactive display system of claim 1, wherein the x-axis on the graph comprises:
a middle portion of the graph within which coordinate positions represent neutral or balanced measures of information source political bias.

13. The interactive display system of claim 12, wherein the x-axis further represents degrees of politically left bias to a left side of the middle portion of the graph and degrees of politically right bias to a right side of the middle portion of the graph.

14. The interactive display system of claim 2, wherein the individual article ranking data comprises individual element scores, the individual element scores comprising each of:
a headline score;
a graphic score;
a lede score; and
a plurality of individual sentence scores.

15. The interactive display system of claim 2, wherein the individual article ranking data comprises bias instance scores for instances of each of:
political position descriptions;
linguistic bias indicators; and
characterizations of political figures.

16. The interactive display system of claim 2, wherein the system further comprises:
a machine learning program configured to receive a first set of individual articles with a first set of human-scored individual element scores as inputs and score a plurality of additional articles, scoring each of individual elements of the plurality of additional articles with machine-scored individual element scores based on learning from the human-scored individual element scores.

17. The interactive display system of claim 16, wherein the machine-scored individual element scores are used by the ranking application to automatically place the graphical representation of the information source.

18. The interactive display system of claim 2, wherein the interactive show ranking data comprises guest ratings, the guest ratings comprising one or more of:
guest type;
guest political stance on topic; and
guest expertise on subject matter.

19. The interactive display of claim 1, further comprising a plurality of graphical representations of a plurality of information sources, and wherein the interactive user interface is configured to allow a user to select a subset of the plurality of information sources to view.

20. The interactive display system of claim 1, wherein the interactive user interface is configured to allow a user to download an image showing the subset of the plurality of information sources selected by the user.
